(19) United States
(12) Patent Application Publication
(10) Pub. No.: US 2006/0208212 A1
(43) Pub. Date: Sep. 21, 2006

(54) Method for closing off a throttle valve housing

(75) Inventor: Thomas Hannewald, Griesheim (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/389,042

(22) Filed: Mar. 27, 2006

Related U.S. Application Data
(63) Continuation of application No. PCT/DE03/02782, filed on Aug. 21, 2003.

(30) Foreign Application Priority Data
Sep. 4, 2002 (DE) 102 40 910.2

(51) Int. Cl. F16K 1/22

(52) U.S. Cl. 251/305

(57) ABSTRACT

Disclosed is a method for sealing a throttle valve port, according to which a bottom part of a two-piece throttle valve is fixed to a throttle valve shaft in a first step, whereupon at least one elastic compensating element is placed upon the bottom part in a second step. A top part of the two-piece throttle valve is then positioned on the at least one elastic compensating element and is fixed to the throttle valve shaft in a third step. A medium is introduced between the bottom part and the top part and the at least one elastic compensating element by means of the bottom part or the top part in a fourth step, whereby the at least one elastic compensating element is pressed against the inner wall of the throttle valve port. In a fifth step, the at least one elastic compensating element which is pressed against the inner wall of the throttle valve port is connected to the bottom part and the top part of the two-piece throttle valve.

### CROSS REFERENCE TO RELATED APPLICATIONS

The present application is a continuation of international application PCT/DE2003/002782, filed 21 Aug. 2003, and further claims priority to German patent application 10240910.2, filed 4 Sep. 2002, the both of which are herein incorporated by reference.

### BACKGROUND OF THE INVENTION

Methods for closing off throttle valve housings are known. Closing off in this case takes place by means of throttle valves which are arranged centrally in the throttle valve housing on a throttle valve shaft. For as low an idling rotational speed as possible, the throttle valve must in this case be capable of closing with a high degree of leak tightness, so that adverse leakage air is avoided. In the case of present-day mechanically or electrically driven throttle valve housings, attempts are made to achieve this by means of very narrow tolerances of the individual components. This requires a relatively high outlay in manufacturing terms for the throttle valve housing and for the throttle valve which has to be lathe-turned with the highest possible precision to these narrow tolerances. At the same time, care must be taken to ensure that the throttle valve bears against the inner wall of the throttle valve housing in as leak tight a manner as possible, but does not touch the inner wall too firmly, since a jamming of the throttle valve may otherwise occur.

### SUMMARY OF THE INVENTION

The object on which the invention is based is thus to provide a method for closing off a throttle valve housing, in which a complicated remachining of the throttle valve housing or of the throttle valve may be dispensed with.

The object on which the invention is based is achieved by means of a method for closing off a throttle valve housing, in which in a first step a lower part of a two-part throttle valve is fixed to a throttle valve shaft, in a second step at least one elastic compensation element is laid onto the lower part, in a third step an upper part of the two-part throttle valve is laid onto the at least one elastic compensation element and is fixed to the throttle valve shaft, in a fourth step a medium is introduced through the lower part or the upper part between the lower part and the upper part and the at least one elastic compensation element, and the at least one elastic compensation element is pressed against the inner wall of the throttle valve housing, and, in a fifth step, the at least one elastic compensation element pressed against the inner wall of the throttle valve housing is connected to the lower part and to the upper part of the two-part throttle valve. The two-part throttle valve may in this case consist, for example, of two circular metal sheets which centrally are formed complementarily to the throttle valve shaft. The latter is thus formed by the upper part and the lower part. The diameter of the two-part throttle valve is selected such that, after the two-part throttle valve is fixed to the throttle valve shaft, a gap of, for example, 0.1 to 0.5 mm remains between the two-part throttle valve and the inner wall of the throttle valve housing. The fixing of the lower part or of the upper part of the two-part throttle valve to the throttle valve shaft may take place, for example, in that both the lower part and the upper part are fastened to the throttle valve shaft. It is also possible, however, merely to mount the lower part and the upper part by pressing them against the throttle valve shaft in a correspondingly desired way. In the second step, at least one elastic compensation element is laid onto the lower part. In this case, for example, two elastic compensation elements may be used, which have a part-circular configuration and bear with their ends against the throttle valve shaft. However, these ends may also, for example, be guided along on the throttle valve shaft. In any event, the elastic compensation elements must have a free space centrally, so that a cavity is formed between the lower part of the two-part throttle valve, the elastic compensation element and the upper part of the two-part throttle valve. In the fourth step, the medium is then introduced into this cavity, and the medium used may be, for example, air or another gas. The at least one elastic compensation element is selected in terms of its dimensions such that, after being laid onto the lower part of the two-part throttle valve, a gap of, for example, 0.1 to 0.5 mm remains between said compensation element and the inner wall of the throttle valve housing. The at least one elastic compensation element is pressed by the introduced medium against the inner wall of the throttle valve housing. The introduction of the medium in this case takes place through passage orifices in the lower part or in the upper part of the two-part throttle valve. It can thus be introduced both through the lower part and through the upper part or only through the lower part or only through the upper part of the two-part throttle valve. Where larger throttle valve housings are concerned, appropriate venting must, of course, be ensured in this case. In the position in which the at least one elastic compensation element is pressed against the inner wall of the throttle valve housing, in the fifth step the connection between the at least one elastic compensation element and the lower part and the upper part of the two-part throttle valve is carried out. The connection may in this case take place positively or frictionally, depending the choice of materials for the elastic compensation element and the two-part throttle valve. Thus, a positive connection may take place, for example, by means of the arrangement of rivets. It was shown, surprisingly, that, according to this method, a closing off of the throttle valve housing can take place in such a way that there is no formation of leakage air when the idling rotational speed is set. In this case, it is advantageous that the setting of low tolerance ranges of the two-part throttle valve and of the throttle valve housing may be dispensed with. The two-part throttle valve therefore does not have to be lathe-turned with the highest possible precision, and the throttle valve housing likewise does not have to be remachined in a complicated way on its inner wall.

In a preferred embodiment of the invention, the fixing of the lower part and of the upper part of the two-part throttle valve to the throttle valve shaft takes place by the pressing of a first die and of a second die which are introduced into the throttle valve housing on both sides. The first die and the second die are, as a rule, shaft pieces which have a circular configuration in cross section and which are formed, at their ends facing the throttle valve shaft, complementarily to the lower part and to the upper part of the two-part throttle valve respectively. Either the first die or the second die or both must in this case have a supply duct for the medium, the outlet of which terminates flush with the respective perforation orifice of the lower part or of the upper part of the two-part throttle valve. They bear against the inner wall of the throttle valve housing in a leak tight manner, advantageously sealing off with respect to the surroundings being achieved at the same time. It is particularly advantageous, in this respect, that additional fastening elements, such as screws or rivets, for fixing the lower part or the upper part of the two-part throttle valve to the throttle valve shaft may be dispensed with.

According to a further preferred embodiment of the invention, the medium introduced is a mounting foam. The mounting foam used may in this case be, for example, a mounting adhesive foam based on MS-polymer, such as is sold by the company Henkel. This advantageously ensures that the at least one elastic compensation element is pressed uniformly against the inner wall of the throttle valve housing, so that uniform conditions over the entire part-circular region can be set at the connection point between the at least one elastic compensation element and the inner wall of the throttle valve housing.

According to a further preferred embodiment of the invention, the elastic compensation element is of one-part design and has two opposite perforations, the second step is dispensed with, and before the first step, in a preliminary step, the elastic compensation element is pushed with the two opposite perforations onto the throttle valve shaft. The two opposite perforations may in this case be configured such that they project in each case into the bearing bores for the throttle valve shaft. Sealing off against air with respect to the shaft perforation is thereby advantageously achieved. The inside diameter of the opposite perforations thus corresponds approximately to the outside diameter of the throttle valve shaft, and, of course, it is necessary to ensure that the elastic compensation element can still be pushed onto the throttle valve shaft. The position of the elastic compensation element is thereby advantageously simplified.

According to a further embodiment of the invention, there is provision for the use of a two-part throttle valve made from metal and of at least one elastic compensation element made from plastic. This simplifies the pressing of the at least one elastic compensation element against the inner wall of the throttle valve housing.

According to a further preferred embodiment of the. invention, a two-part throttle valve made from plastic and at least one elastic compensation element made from plastic are used. A connection of the two-part throttle valve to the at least one elastic compensation element is thereby advantageously facilitated.

According to a further embodiment of the invention, the plastic used is polyamide-6. Polyamide-6 is particularly resistant, precisely under the conditions such as are to be noted in the throttle valve housing during operation.

According to a further preferred embodiment of the invention, a two-part throttle valve made from aluminum and at least one elastic compensation element made from aluminum are used. The elastic compensation element in this case is in the form of a thin metal strip. It is advantageous, in this case, that a connection of the two-part throttle valve to the at least one elastic compensation element can be carried out by spot welding.

According to a further preferred embodiment of the invention, the at least one elastic compensation element pressed against the inner wall of the throttle valve housing is connected to the lower part and the upper part of the two-part throttle valve by adhesive bonding, the adhesive being applied to the lower part or the upper part or the at least one elastic compensation element in the preliminary step or in the second step or in the third step. The adhesive used in this case may be, for example, a two-component adhesive based on methacrylate (for example, from Pattex Stabilitexpress). The fastening of the at least one elastic compensation element to the two-part throttle valve can thereby take place particularly simply, while an arrangement of further fastening elements, such as, for example, rivets, may be dispensed with.

In a further preferred embodiment of the invention, the connection of the at least one elastic compensation element pressed against the inner wall of the throttle valve housing to the lower part and the upper part of the two-stage throttle valve takes place by lasing. As a result, between the two-part throttle valve and the at least one elastic compensation element, a particularly stable connection can be achieved which remains stable over lengthy operating periods and can be produced relatively simply.

According to a further preferred embodiment of the invention, the connection of the at least one elastic compensation element pressed against the inner wall of the throttle valve housing to the lower part and the upper part of the two-part throttle valve takes place solely by means of the mounting foam used as medium. In this case, it is advantageous that a connection takes place directly after the pressing of the at least one compensation element against the inner wall of the throttle valve housing, and that any further connection elements, such as rivets, screws or adhesives, may advantageously be dispensed with.

### BRIEF DESCRIPTION OF THE SEVERAL VIEWS OF THE DRAWINGS The invention is explained in more detail below, by way of example, with reference to the drawing (FIG. 1 to FIG. 3).

FIG. 1 shows a throttle valve housing in cross section with the two-part throttle valve and with a one-part elastic compensation element.

FIG. 2 shows the throttle valve housing in cross section according to section A-A in FIG. 1.

FIG. 3 shows a throttle valve housing in cross section with the two-part throttle valve, with a two-part elastic compensation element and with a first die and a second die.

### DETAILED DESCRIPTION OF THE INVENTION

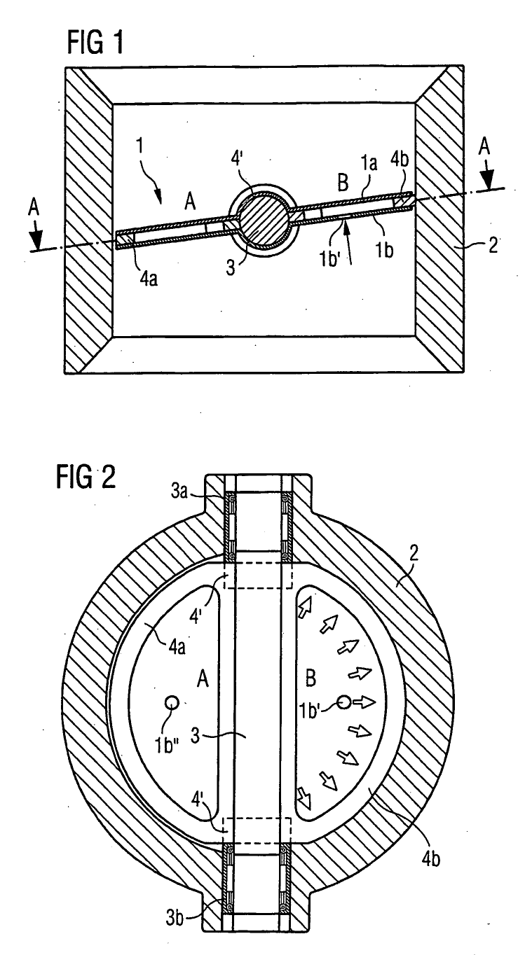

FIG. 1 illustrates the throttle valve housing 2 in cross section. The half illustration A in this case shows the state in which the elastic compensation element 4a still has some clearance with respect to the throttle valve housing 2. In the half illustration B, the elastic compensation element 4b bears directly against the inner wall of the throttle valve housing 2. In the method for closing off the throttle valve housing 2, in a first step, a lower part 1b of a two-part throttle valve 1 is fixed to the throttle valve shaft 3. In a second step, at least one elastic compensation element 4a, 4b is laid onto the lower part 1b. In a third step, the upper part la of the two-part throttle valve 1 is laid onto the at least one elastic compensation element 4a, 4b and is fixed to the throttle valve shaft. This state is shown in the half illustration A. According to FIG. 1, the elastic compensation elements 4a, 4b are of one-part design and have two opposite perforations 4′ which have a semicircular or circular configuration and the inside diameter of which corresponds virtually to the outside diameter of the throttle valve shaft 3. If such an elastic compensation 4a, 4b is used, the second step of the method is dispensed with, and before the first step, in a preliminary step, the elastic compensation element 4a, 4b is pushed with the two opposite perforations 4′ onto the throttle valve shaft 3. The first step subsequently takes place, in which the lower part 1b of the two-part throttle valve 1 is fixed to the throttle valve shaft 3. In so far as the connection between the at least one elastic compensation element 4a, 4b and the two-part throttle valve 1 is to be carried out with the aid of an adhesive, care must be taken to ensure that the adhesive used is applied to the lower part 1b or the upper part 1a or the at least one elastic compensation element 4a, 4b in the preliminary step or in the second step or in the third step. It is in this case possible, of course, to provide a plurality of parts with the adhesive. In a fourth step, a medium is introduced in the direction of the arrow through the lower part 1b, through the passage orifice 1b′, between the lower part 1b and the upper part 1a and the at least one elastic compensation element 4b. In this case, for example, the medium used may be gases. It is also possible, however, to introduce as medium a mounting foam which serves at the same time for fastening the at least one elastic compensation element 4b to the lower part 1b and the upper part 1a of the two-part throttle valve 1. By the medium being introduced, the at least one elastic compensation element 4a, 4b is pressed against the inner wall of the throttle valve housing 2. Finally, in a fifth step, the connection of the at least one elastic compensation element 4a, 4b pressed against the inner wall of the throttle valve housing to the lower part 1b and the upper part 1a of the two-part throttle valve 1 is carried out.

FIG. 2 illustrates the throttle valve housing 2 in cross section according to section A-A in FIG. 1. The two opposite perforations 4′ of the one-part compensation element 4a, 4b are illustrated merely by broken lines, in order to make it clear that the elastic compensation elements 4a, 4b can also be used separately from one another in two parts. In this case, it is necessary to provide a further passage orifice 1b″, for example in the lower part 1b of the two-part throttle valve 1, in order to introduce the medium correspondingly, as illustrated in FIG. 2. However, in so far as the at least one elastic compensation element 4a, 4b has a one-part configuration and has two opposite perforations 4′, it is possible for these also to project into the bearing bores of the bearings 3a, 3b, with the result that a sealing off against air with respect to the shaft perforation can advantageously be achieved.

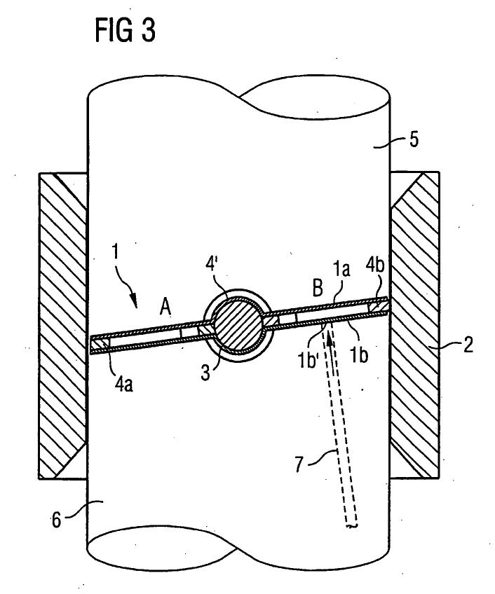

FIG. 3 illustrates the throttle valve housing 2 in cross section. The fixing of the lower part 1b and of the upper part 1a of the two-part throttle valve 1 to the throttle valve shaft 3 takes place by the pressing of a first die 6 and of a second die 5 which are introduced into the throttle valve housing 2 on both sides. They have a circular configuration in cross section and are formed, at their ends facing the throttle valve shaft 3, complementarily to the two-part throttle valve. The first die 6 has a supply duct 7, through which the medium can be introduced. That end of the supply duct 7 which faces the two-part throttle valve 1 issues directly into the passage orifice 1b′ of the lower part 1b of the two-part throttle valve 1. The first die 6 and the second die 5 bear sealingly against the inner wall of a throttle valve housing 2. It is also possible, however, to provide the second die 5 with corresponding ducts (not illustrated) for the supply of media or for venting.

What is claimed is:

1. A method for closing off a throttle valve housing comprising the steps of:
fixing a lower part of a two-part throttle valve to a throttle valve shaft;
laying at least one elastic compensation element onto the lower part;
further laying an upper part of the two-part throttle valve onto the at least one elastic compensation element;
introducing through the lower part or the upper part a medium between the lower part and the upper part and the at least one elastic compensation element and pressing the at least one elastic compensation element against the inner wall of the throttle valve housing; and
connecting the at least one elastic compensation element to the lower part and the upper part of the two-part throttle valve.

2. The method according to claim 1, wherein the step of fixing is effected by pressing a first die and a second die which are introduced into the throttle valve housing on both sides.

3. The method according to claim 1, wherein the medium is a mounting foam.

4. The method according to claim 1, wherein:
the elastic compensation element is of a one-part design and comprises two opposite perforations,
the step of laying is omitted, and
further comprising an initial step of pushing an elastic compensation element with two opposite perforations onto the throttle valve shaft.

5. The method according to claim 1, wherein the two-part throttle valve comprises metal and at least one elastic compensation element made from plastic.

6. The method according to claim 1, wherein the two-part throttle valve and the at least one elastic compensation element comprises plastic.

7. The method according to claim 5, wherein the plastic is polyamide-6.

8. The method according to claim 1, wherein the two-part throttle valve and the at least one elastic compensation element comprises aluminum.

9. The method according to claim 1, further comprising the steps of:
connecting the at least one elastic compensation element to the lower part and the upper part of the two-part throttle valve with adhesive bonding, the adhesive being applied to the lower part or the upper part or the at least one elastic compensation element in an earlier step.

10. The method according to claim 1, wherein the connection of the at least one elastic compensation element pressed against the inner wall of the throttle valve housing to the lower part and the upper part of the two-stage throttle valve takes place by lasing.

11. The method according to claim 1, wherein the connection of the at least one elastic compensation element pressed against the inner wall of the throttle valve housing to the lower part and the upper part (1a) of the two-part throttle valve takes place solely by means of the mounting foam used as a medium.

12. The method according to claim 2, wherein the medium is a mounting foam.

13. The method according to claim 3, wherein:
the elastic compensation element is of a one-part design and comprises two opposite perforations,
the step of laying is omitted, and
further comprising an initial step of pushing an elastic compensation element with two opposite perforations onto the throttle valve shaft.

14. The method according to claim 6, wherein the plastic is polyamide-6.
